(19) United States
(12) Patent Application Publication
(10) Pub. No.: US 2005/0072765 A1
(43) Pub. Date: Apr. 7, 2005

(54) Method and device for arc welding of elements to coated parts

(76) Inventors: Klaus Gisbert Schmitt, Giessen (DE); Joachim Schneider, Ehringshausen (DE)

Correspondence Address: HARNESS, DICKEY & PIERCE, P.L.C., P.O. BOX 828, BLOOMFIELD HILLS, MI, 48303, US

(21) Appl. No.: 10/613,450

(22) Filed: Jul. 3, 2003

(30) Foreign Application Priority Data
Jul. 4, 2002 (DE) DE 102 30 846.2

(51) Int. Cl. B23K 9/20

(52) U.S. Cl. 219/99; 219/98

(57) ABSTRACT

A device and a method are proposed for arc welding of elements, in particular metal studs to coated parts, in particular metal sheets, in which in a first step an element is moved relative to the part to at least partially break up the coating of the part. This produces an electrical contact between part and element, the part and the element being welded to each other in a subsequent step. The element is set in oscillating motion, at least about its lengthwise axis, in order at least partially to break up the coating of the part.

### CROSS-REFERENCE TO RELATED APPLICATIONS

This application claims the benefit of German foreign application DE 102 30 846.2, filed Jul. 4, 2002. The disclosure of the above application is incorporated herein by reference.

### FIELD OF THE INVENTION

The invention relates to a method of arc welding of elements, in particular metal studs, to coated parts, in particular metal sheets, in which, in a first step, an element is moved relative to the part, in order at least partially to break up the coating of the part to produce an electrical contact between part and element, the part and the element being welded to each other in a subsequent step. The invention relates further to a device for arc welding of elements, in particular metal studs, to parts, in particular metal sheets, having a welding head in which a holder is provided to accommodate an element to be welded, having a power supply means to supply electrical energy, and having means to move the holder relative to the part. The invention relates, lastly, to an element specially suited for use with such a method.

### BACKGROUND OF THE INVENTION

U.S. Pat. No. 3,340,379 discloses a method and a device for arc welding of elements to metal sheets provided with a coating, e.g. a coat of varnish. For this purpose, the elements, on the surface facing the part, comprise pointed projections by which the coating is pierced, to establish metallic content between element and part. Then element and part are connected to each other by arc welding.

In so-called short-time arc welding, also generally known by the term Bolzenschweiβen [stud welding], an element accommodated in a holder is first lifted relative to the part, in the context of a welding operation, a welding arc is set up between element and part, and the element is then lowered again.

The technology of stud welding is employed especially, though not exclusively, in the vehicular field. By this technology, studs with or without threads, nuts, loops and other elements can be welded to bodywork sheets, The elements then usually serve as anchors for attachment of interior trim, for example, to the bodywork of the vehicle. By the method initially mentioned, such stud welding may be performed in principle even on coated, for example painted, bodywork sheets.

The use of the known method, however, is problematical when the parts, for example the bodywork sheets, are very thin, and therefore permanent deformations are to be expected when the coating is broken up by pressing against the projections of the element.

DE A 199 25 628 further discloses a method and a device for stud welding in which the part, prior to the actual welding operation, is first cleaned by an arc using short-time arc welding. This is especially suitable for use on sheet steel or aluminum, comprising an organic coating or galvanized. The coating may for example be a film of wax. The known method and the known device, while suitable for use on parts provided with a thin coating or galvanized, are not suitable for use on an insulating coating with good adhesion, such as for example a coat of paint or varnish.

The object of the invention, then, is to create a method and a device for arc welding of elements to coated parts, in which the aforementioned disadvantages are avoided. In particular, the production of lasting, high-quality welding of elements to metallic parts is to be made possible also when the latter are of only a small thickness and provided with a dense insulating coating, such as a coat of varnish. Further, elements specially suited for use with such a method are to be specified. This object is accomplished, in a method of the kind initially mentioned, in that the element is set in oscillating motion about its lengthwise axis, in order at least partially to break up the coating of the part.

This object is accomplished further in a device of the kind initially mentioned, in that the holder can be driven in oscillating motion about its lengthwise axis. In this way, the object of the invention is accomplished in its entirety. For according to the invention, by the oscillating motion of the element about its lengthwise axis, a conservative disintegration or scoring of the coating of the part at its surface is made possible, even in the case of a part of only very small thickness, for example a sheet-metal thickness of 1 mm or less.

In a preferred refinement of the invention, the element is additionally set in oscillating motion in axial direction, to and fro relative to the part. In this way, the disintegration of the coating can be supported to produce a first electrical contact between the part and the element.

According to another embodiment of the invention, the part is freed from remnants of the coating by means of an excess pressure or a negative pressure. In this way, portions of the coating that have been broken up or flaked off by the oscillating motion of the element relative to the part can be either blown or aspirated away in order to leave the part as clean as possible in the region where the subsequent weld between part and element is to be produced.

An element especially suited for performance of the welding operation according to the invention comprises a flange portion to be welded to the part, on which portion elevations are provided to score the coating of the part. This flange portion comprises a projection of annular configuration, on the faces of which the said elevations are formed. With such elements, high-grade welds can be produced even on parts of especially small thickness. In particular, the welding of an element onto a part in the neighborhood of an opening is made possible, so that in particular an element having an internal thread may be welded onto a part and be subsequently accessible through the opening.

In the welding operation according to the invention, preferably the first step, in which the coating of the part is at least partially broken up or scored, is followed by a second step in which the part is cleaned by means of an electric arc. In this way, an especially conservative treatment of the part is made possible.

In further preferred refinement of the invention, the arc is deflected by a magnetic field during the cleaning step. Here the magnetic field is preferably so oriented that the arc travels around the lengthwise axis of the element in a closed path during the cleaning step. In this way, a cleaning of the surface of the part, especially in the region where the later welding, preferably to an element comprising an annular projection, are carried out in especially conservative manner.

In additional refinement of the invention, the second step is followed by a third step in which the polarity of the voltage between part and element is reversed and the element is welded to the part. In this way, the cleaning of the surface of the part can be controlled by alteration of the arc. Since the welding here immediately follows the step of cleaning by means of the electric arc, an especially short cycle time results. By reversing the polarity of the voltage between part and element, during the preceding step of cleaning, with positive polarity of the element, a greater enlargement of the arc can be achieved. On the other hand, upon ensuing reversal with negative polarity of the element, the arc is more concentrated, appropriately to establishment of a welded connection in the next step.

In the device according to the invention, the drive of the holder to generate the oscillating motion about its lengthwise axis may be magnetic. For this purpose, the holder may be coupled to a drive lever having a radial segment, movable to and fro between two coils located opposed to each other. This is an especially simple possibility for producing the oscillating motion about the lengthwise axis of the holder.

In an alternative embodiment, the holder is coupled to an eccentric drive to generate the oscillating motion about the lengthwise axis. In this way also, the oscillating motion about the lengthwise axis can be generated by relatively simple means. For the drive in axial direction, preferably a linear motor is provided. In this way, the linear motor, usually employed in any case to move the element relative to the part, may be employed likewise to generate an oscillating motion to support cleaning of the coating from the part.

It will be understood that the features of the invention as mentioned above and yet to be illustrated below may be employed not only in the particular combination specified, but also in other combinations or singly, without departing from the scope of the invention.

### BRIEF DESCRIPTION OF THE DRAWINGS

Other features and advantages of the invention will appear from the following description of preferred embodiments by way of example with reference to the drawing, in which:

FIG. 1 shows a device according to the invention in much simplified schematic representation;

FIG. 2 shows a side view of the welding head in FIG. 1, in enlarged but likewise simplified representation;

FIG. 3 shows a section through the holder of FIG. 2 along the line III-III;

FIG. 4 shows a representation similar to FIG. 3 with an alternative embodiment of the drive to generate the oscillating motion of the holder about its lengthwise axis;

FIG. 5 shows a longitudinal section of an element to be welded, in a first embodiment;

FIG. 6 shows a front view of the element according to FIG. 5;

FIG. 7 shows a schematic representation clarifying the circulation of the spot of light under the influence of a magnetic field;

FIG. 8 shows the course of the electric arc current I and of the distance s of the element from the part as functions of time t during the cleaning step and the ensuing welding step;

FIG. 9 shows a longitudinal section of the welding head with associated part in the anterior portion of the holder; and

FIGS. 10-14 show various embodiments of elements to be welded in side view and in front view as seen from the part.

### DETAILED DESCRIPTION OF THE PREFERRED EMBODIMENTS

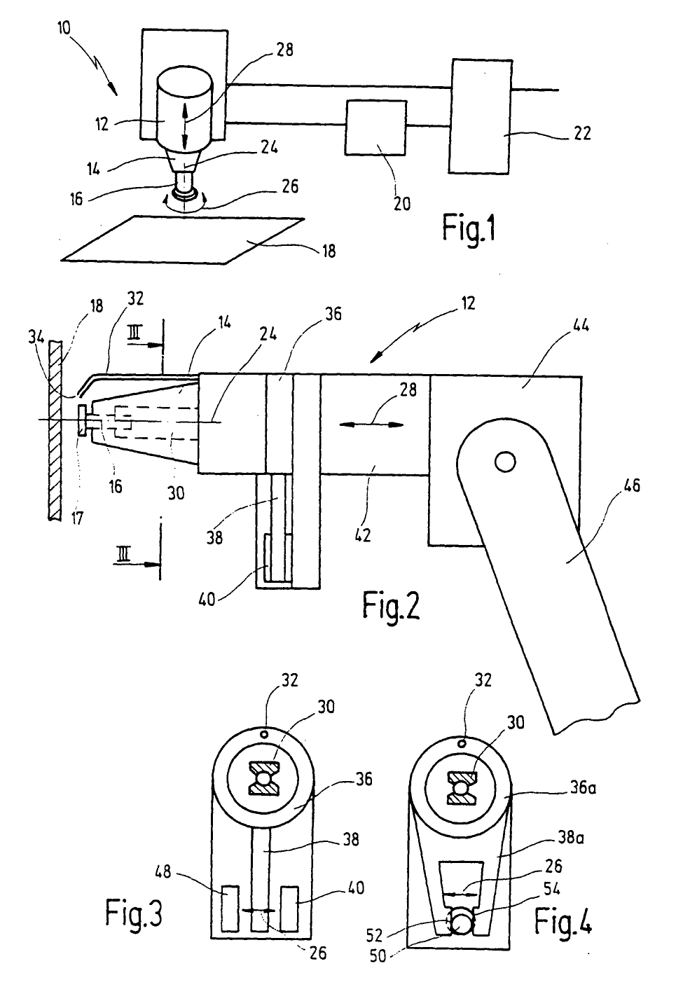

In FIG. 1, a device for welding of metal elements 16 to parts 18 is represented very schematically and designated as a whole by the numeral 10. The metal elements 16, in the case shown, might for example be studs, to be welded onto a painted bodywork sheet. As welding method, use is made for this purpose of so-called short-time arc welding, known in principle. The device 10 comprises a welding head 12, which in the case of a vehicular application is generally accommodated by a robot arm 46 (cf. FIG. 2). In the welding head 12, a holder 14 is provided to accommodate an element 16 to be welded. Elements to be welded are fed to the holder 14 from an element feeding means 20, for example by means of compressed air. The power required for short-time arc welding is furnished by a power supply means 22 coupled to a control means.

The holder 14, and with it an element 16 to be welded therein contained, is movable in to-and-fro oscillation about the lengthwise axis 24 of the holder, as indicated by the double arrow 26. Further, the holder 14 is movable by a suitable drive relative to the part 18, not only to and fro for the welding operation itself, but also in oscillation to and fro before the welding operation begins, as indicated by the double arrow 28.

According to FIG. 2, the holder 14 is accommodated on the welding head 12, a tension tongs 30 being provided therein to hold elements 16 to be welded. The tension tongs 30 is movable in oscillation about the lengthwise axis 24 of the holder 14 by means of a drive lever 36. For this purpose, the drive lever 36 comprises a radial segment 38 (cf. FIG. 3) movable to and fro between two opposed coils 40, 48, as indicated by the arrow 26. At least the radial segment 38 of the drive lever 36 is configured in a ferromagnetic material for this purpose. The polarity of the coil 40, 48 is periodically reversed, for which purpose the direction of a suitable direct current passing through the coils is reversed in each instance. The radial segment 38 is thus alternately attracted to the one coil 40 and to the other coil 48, and the drive lever 36 executes oscillating motions as a result. It will be understood that such an oscillating motion may also be achieved by means of an eccentric drive, as represented for example in FIG. 4. The drive lever 36a is here configured as a swing lever 38a, comprising two mutually opposed plane guide surfaces 52, 54, in contact with an eccentric 50, so that an eccentric motion is converted into an oscillating motion of the drive lever 36a.

According to FIG. 2, in the neighborhood of the holder 14, a gas line 32 is provided as well, opening next to an element 16 to be welded, in the neighborhood of its head or flange 17, into an aperture 34.

The drive mechanism for the oscillating drive 38, 40, or 38a, 50, 52, 54, is movable forward and back relative to the part in manner not shown in detail by means of a linear motor 42. The linear motor 42 is connected by way of a receptacle 44 to the robot arm 46, by which the welding head 12 is positioned in suitable manner, preferably under digital control, in relation to the part 18. Prior to the actual welding of the element 16 to the part 18, a mechanical disintegration of the coating of the part and a subsequent cleaning of the surface of the part in the neighborhood of the subsequent weld, with the aid of an electric arc, take place. These steps of the process are briefly explained as follows:

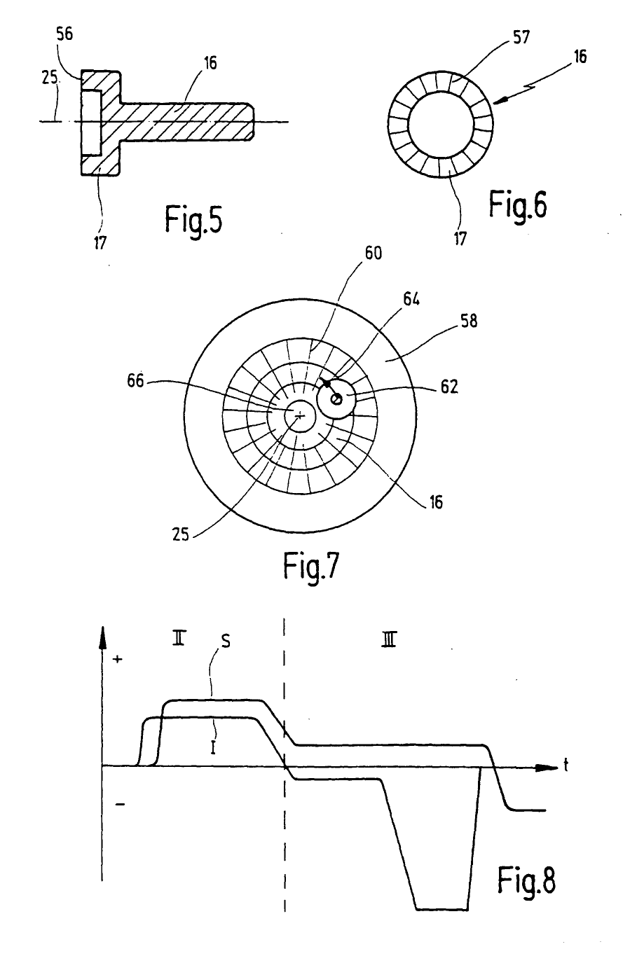

First an element 16 is fed from the element feeding means 20 into the tension tongs 30 of the holder 14, for example by means of compressed air. The element 16 may for example have a shape according to FIGS. 5 and 6. Here the element 16, on its side facing the part 18, comprises a flange area 17, at which, on the side towards the part, an annular projection 56 is provided, so that upon the whole, a pot-shaped form of the flange area 17 results. The particular element 16 is of rotationally symmetrical configuration, as indicated by the axis of symmetry or lengthwise axis 25. Upon subsequent accommodation of the element 16 in the tension tongs 30, the lengthwise axis 25 of the element 16 will coincide with the lengthwise axis 24 of the holder 14, or of the tension tongs 30.

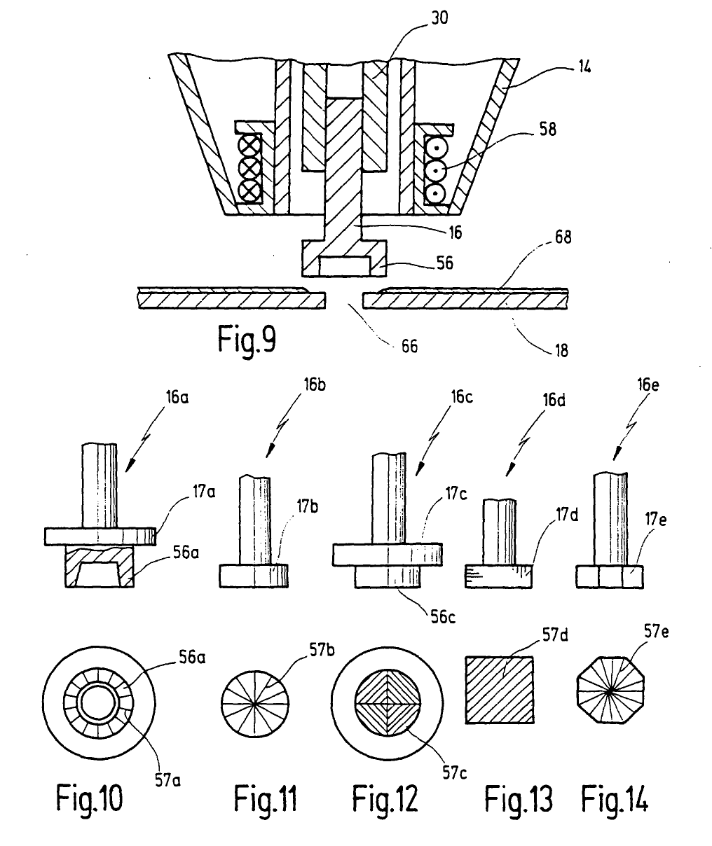

As may be seen from the view of the face of the element 16 in FIG. 6, the surface of the annular projection 56 facing the part features elevations 57, representing, in the case shown, radially extending projections or edges. Now if an element 16 to be welded is accommodated in the tension tongs 30, it will first be run up to the surface of the part as in FIG. 9 by means of a linear motor 28, while the tension tongs 30 is driven in oscillation about its lengthwise axis. In addition, an oscillating motion of the tension tongs 30 in axial direction may be superimposed. By this relative motion between part 18 and element 16, the coating 68 adhering to the surface of the part (e.g. a coat of paint) will be scored in the neighborhood of the annular projection 56, so that at least partially an electrical contact will be made between the element 16 and the part 18. This is the first step of the complete three-step process of producing a weld. Additionally, the gas line 32 is now charged with compressed air, to free the part 18 from remnants of the coating 68 in the neighborhood of the future weld.

Now, in the second step of the process, comes a cleaning of the surface of the part with the aid of an electric arc. For this purpose the element 16, starting from an electric contact according to FIG. 8, an electric arc being set up with positive polarity of the element 16 and negative polarity of the part, is first lifted, as indicated by the distance s. Thus an arc is set up, by which any coating 68 still adhering to the surface of the part 18 is evaporated, so that the surface of the part is cleaned. This is referred to as the so-called “clean flash” process. In FIG. 8, this cleaning step, in which the arc is enlarged towards the part owing to the positive polarity, is identified as Phase II.

During the cleaning Phase II, the incipient cleaning current is preferably regulated to a magnitude between about 20 and 500 amperes. This cleaning intensity is preferably held more or less constant for a certain period of time, as indicated by the time curve during Phase II in FIG. 8. After a brief time delay, after the current I has been switched on, the element is lifted from the surface of the part 18 and preferably brought to a more or less constant distance s. The cleaning amperage is kept constant; the arc voltage adjusts itself according to the distance s and the extent of cleaning. The distance s is on the order of about 3 mm. After a period of time At, beginning with the lifting of the element from the surface of the part 18 and ending with the decline of the cleaning amperage to 0 amperes, the surface of the part is clean. The duration Δt is for example set to between about 15 and 120 milliseconds.

In an immediately following Phase III, the polarity of the voltage between part and element is reversed, so that the element is on negative polarity while the part is positively polarized. After a brief pilot current serving for stabilization of the welding current, the welding current is set more or less to a range between 500 and 1500 amperes to establish a permanent weld between part and element. The element to be welded on, which has again been in contact with the surface of the part, is removed from the surface again for this purpose (cf. FIG. 8). During the welding phase following the pilot current phase, the surface of the part is fused to such an extent as to make an adequate band depth available. After decline of the welding current to 0 amperes, a certain waiting time is observed, so that the weld bath becomes viscid. Only then is the element to be welded dipped into the surface, producing the welded connection.

The arc is controlled or deflected during the cleaning phase by means of a magnetic field, as indicated schematically by FIG. 7. The magnetic field may for example be generated by a coil 58 as in FIG. 9. If the arc 62 is located in the neighborhood of the scatter field of the coil 58, i.e. in the neighborhood of the axial end of the coil, then the lines of force, indicated in FIG. 7 by the numeral 60, run more or less in radial direction in this neighborhood. In this way, a rotating arc 62 results, with a diameter of about 3 to 4 mm, revolving in a circular path about the lengthwise axis 25 of the element. The direction of the force exerted on the arc 62, in accordance with the Lenz rule, is indicated in FIG. 7 for example by the arrow 64. By the revolving arc, an excessively local heating is avoided, as is advantageous especially for thin parts, and especially when using elements having annular projections 56 according to FIGS. 5 and 6.

The coil 58 is preferably operated on an alternating current, amounting to between about 8 and 30 volts. Preferably an amperage between about 0.1 and 2 amperes is set. Since during an actual welding operation in Phase III also, a control of the arc is desirable, not as a rule an arc revolving in a circular path, but an arc focused on the location of the weld, optionally a travel of the coil 58 may be provided relative to the tongs 30, to bring the arc into the axial magnetic field of the coil 58 for the welding operation, whereby an orientation of the arc on the lengthwise axis 25 of the element is brought about.

As may be seen in FIGS. 7 and 9, the part 18 may comprise an opening or a hole 66 in the neighborhood of the weld to be produced, around which opening the projection 56 of the element 16 is to be welded on. An element 16 having an annularly projecting feature 56 may be employed to advantage in such cases especially. With suitable dimensioning of the hole 66 and of the annular projection 56, in this way, an element 16 having an internal thread may also be welded to the part 18, and subsequently used through the opening 66 to make a screw connection through the hole 66.

It will be understood that the element 16 may take a very wide variety of forms, as illustrated for example by the elements 16a, 16b, 16c, 16d, 16e in FIGS. 10, 11, 12, 13 and 14.

According to FIG. 10, the flanged area 17a comprises an annular projection 56a, projecting to form a shoulder on the outside of the flange neighborhood 17a, projecting from the latter towards the part. Again, on the face of the annular projection 56a, elevations 57a are provided in the form of edges extending radially.

According to FIG. 11, the flange neighborhood 17b is of plane configuration and again comprises radially extending elevations 57 in the form of edges on its face towards the part.

In the embodiment of FIG. 12, a cylindrical projection 56c is provided on the flange neighborhood 17c, projecting towards the part. The face of the projection 56c towards the part is divided into four quadrants. In each quadrant, tangentially extending elevations 57c parallel to each other are configured in the form of projecting edges.

In the embodiment according to FIG. 13, the element 16d comprises a square flange neighborhood 17d, on whose part-side face diagonally extending elevations 57d are configured in the form of edges.

In the embodiment according to FIG. 14, the element 16e comprises an octahedrally configured flange neighborhood 17e, on whose part-side face again radially extending elevations 57e are configured in the form of projecting edges.

It will be understood that instead of a gas line 32 provided laterally alongside the holder 14 as in FIG. 1, alternatively a central gas line may be provided, so that the flow of gas takes place from the interval between tongs 30 and holder 14 towards the part 18. Such an embodiment may also be employed to achieve a protective-gas welding. Instead of gas exiting under excess pressure, a negative pressure may be utilized, to remove remnants of the coating 68 from the surface of the part.

1-33. (canceled)

34. A device for arc welding fasteners to a coated sheet metal structure comprising:
a welding head configured to hold the fasteners;
a power supply to supply electrical energy to the fastener;
a mechanism for moving the welding head relative to the sheet metal structure, wherein the mechanism is configured to drive the fastener in an oscillating motion about a lengthwise axis of the fastener;
a holder provided to accommodate the fastener to be welded, wherein the holder is coupled to a drive lever having a radial segment moveable from a first position to a second position between two mutually opposed coils.

35. (canceled)

36. The device according to claim 34 wherein the welding head comprises a magnetic drive to generate oscillating motion about the lengthwise axis.

37. (canceled)

38. A device for arc welding fasteners to a coated sheet metal structure comprising:
a welding head configured to hold the fasteners;
a power supply to supply electrical energy to the fastener;
a mechanism for moving the welding head relative to the sheet metal structure, wherein the mechanism is configured to drive the fastener in an oscillating motion about a lengthwise axis of the fastener; and
a holder provided to accommodate the fastener to be welded, wherein the holder is coupled to an eccentric drive to generate the oscillating motion about the lengthwise axis.

39. The device according to claim 35 wherein the holder is moveable in a first and second direction relative to the structure.

40. The device according to claim 34 further comprising a linear drive coupled to the weld head.

41. The device according to claim 34 wherein a weld head defines an opening which is configured to be connected to a source of one of vacuum or compressed air.

42. The device according to claim 34 further comprising a electromagnet configured to generate a magnetic field to deflect an electronic arc set up between the fastener and the structure on a closed path about a lengthwise axis of the fastener.

43. A device for arc welding a fastener to a coated sheet metal structure comprising:
a welding head configured to hold the fastener;
a power supply configured to supply electrical energy to the fastener; and
a means for moving the fastener relative to the sheet metal to as to cause the fastener to fracture the coating.

44. The device according to claim 43 comprising a means for oscillating the fastener about a longitudinal axis of the fastener.

45. (cancelled)

46. The device according to claim 43 comprising a means for applying a cleaning current so as to produce a cleaning arc between the fastener and the structure.

47. The device according to claim 43 comprising a means for applying a welding current between the fastener and the structure.

48. The device according to claim 43 comprising a means for supplying one of a vacuum or air pressure to the fastener.

49. The device according to claim 46 comprising a means for generating a magnetic field to deflect the cleaning arc.
